(19) United States
(12) Patent Application Publication
(10) Pub. No.: US 2003/0019592 A1
(43) Pub. Date: Jan. 30, 2003

(54) Industrial gate, segment for an industrial gate, and method for manufacturing such a segment

(75) Inventor: Petra Rejc, Landshut (DE)

Correspondence Address: Thomas Langer, Esq., COHEN, PONTANI, LIEBERMAN & PAVANE, 551 Fifth Avenue, Suite 1210, New York, NY, 10176, US

(73) Assignee: EFAFLEX Tor-und Sicherheitssysteme GmbH & Co., KG, Bruckberg (DE)

(21) Appl. No.: 10/119,596

(22) Filed: Apr. 10, 2002

(30) Foreign Application Priority Data
Apr. 19, 2001 (DE) 10119242.8

(51) Int. Cl. E06B 9/08

(52) U.S. Cl. 160/133

(57) ABSTRACT

The invention relates to an industrial gate having a gate body covering the gateway and comprising a multiplicity of segments (21) which are interconnected such that they may be oriented at a relative angle. The segments (21) comprise two profile members (211, 212) extending over the length of the segments (21) and an insert panel (213) which is arranged between these and optionally is translucent, wherein the profile members (211, 212) each have a substantially U-shaped profile groove for receiving the longitudinal edges of the insert panel (213), and wherein one respective elastomer plastic element (214, 215) each is arranged between the longitudinal edges of the insert panel (213) and the inner surface of the profile groove in a press-fit, i.e., under deformation of the plastic element (214, 215) in comparison with the load-free state. The industrial gate in accordance with the invention is characterized in that the gate body—while maintaining the suitability for an external closure as known, e.g., from the fast-moving spiral gate—may be designed variably and in particular may also be formed to be translucent. In addition, a corresponding segment and a method for manufacturing such a segment are provided by the invention.

The invention relates to an industrial gate having a gate body covering the gateway and comprising a multiplicity of segments which are interconnected such that they may be oriented at a relative angle, and which may be formed to be translucent in a center region. The invention moreover relates to a segment for an industrial gate in accordance with claim 9 and a method for manufacturing such a segment in accordance with claim 11.

Rolling gates designed in accordance with the shutter principle and including a gate body of segments, or lamellae, and an upper coiling shaft are known in practical use. These rolling gates are suited as an external closure for buildings e.g. between business periods, however during business hours are normally kept in the opened position as opening and closing movements require much time on account of the very slow movement.

Fast-moving industrial gates were accordingly developed such as known, e.g., from German patent applications DE 40 15 214 A, DE 40 15 215 A and DE 40 15 216 A. These have been found to be excellently suited in practical use and have won preference over customary rolling gates. Whereas in conventional rolling gates the segments of the gate body are fastened to an upper winding shaft and are wound directly onto each other, the segments of the gate body of a like fast-moving spiral gate move in guide rails with the aid of lateral rollers. These are deflected at the top end of the gateway towards the inside of the gate into a straight guide section; following another downward deflection by 180 degrees they are again guided back in a straight line and then optionally again guided to the rear following a 180-degree upward deflection. This results in an elongate coil in which the segments of the gate body do, however, not lie on top of each other but are guided in a spaced-apart relation by the rollers in guides. In this way the moving velocity of the gate body may be raised quite considerably up to approximately 1.5 m per second. Scratching and soiling of the gate body, which are unavoidable if the segments lie on top of each other in the coil and impair the optical appearance of the gate body within a short time, are moreover avoided.

The creation of this type of fast-moving spiral gates has opened up new applications for the principle of the rolling gate: While conventional rolling gates including a winding shaft are employed as a stable gateway closure between business periods (for example during the night) on account of their very slow movement on the one hand, and of the stability of the heavy, predominantly metal gate body on the other hand, and PVC swinging gates arranged behind them in the same passageway frequently provide a provisional closure between the passage of vehicles, fast-moving spiral gates of this type are now often used as a substitute for the two above mentioned types of gates: they provide both a sturdy and reliable external closure of the gateway between business hours and rapid opening and closing movement for the passage of vehicles during business hours. They therefore fulfill the functions both of conventional rolling gates and of the provisional closure such as by means of PVC swinging gates.

The segments of these fast-moving industrial gates are customarily made of aluminum. In practical use, however, it is frequently desired to have the option of seeing into the area behind a closed gate, like for a case where forklifts coming from both sides might at the same time attempt to pass through the gate which is only about to open.

What is basically desired herein is a transparency of the gate body as known, for example, from so-called plasticized PVC rolling gates. These may also be designed as fast-moving rolling gates, with the gate body having the form of a hanging which is coiled above the gateway when the gate is opened. This hanging of plasticized PVC or the like may be designed to be transparent over its full surface, i.e., over the entire height of the gate. Here, however, the turns of the gate hanging come to lie directly on each other in the coil as in conventional rolling gates and are accordingly scratched and soiled, whereby the transparency of the hanging is reduced in the course of time. Another drawback of these rolling gates is that this hanging, although customarily held by the lateral edges in vertical guides, tend to bulge in the center region at higher wind forces owing to stretch of the material in the center region. From a certain wind load upwards, or even in the event of some other manual influence, the lateral edges of the hanging may even come free from the vertical guides of the gateway. These plasticized PVC rolling gates are thus generally not suited as an external closure for a building. They, do, however, on the other hand—at least in the beginning—provide a certain transparency of the hanging as desired by the user in segmented industrial gates.

In conventional fast-moving spiral gates as mentioned at the outset, it accordingly has become accepted practice to make single segments transparent in a center region. To this end, one segment was basically reduced to a frame-type body into which a transparent panel of PMMA (polymethylmethacrylate) or the like is inserted. In practice, this frame-type segment consists of upper and lower profile strips rigidly interconnected at their respective end regions, and in cases of greater gate widths also in the center region of the gate body through the intermediary of a vertical web. The vertical webs are in this case bolted or screwed to the profile strips.

These segments which are translucent in a partial region do, however, present a number of drawbacks. Thus the profile strips and the vertical webs are built comparatively heavy so as to form a stable frame for the transparent panel and yet be furthermore able to absorb the forces acting on the single segments of the gate body. The like segments accordingly have a higher weight than the other, non-transparent segments. This is, however, at the expense of a possible moving velocity for the gate body.

Another drawback of this design resides in the considerably higher expense for assembly which is involved in providing such a translucent segment in comparison with a segment manufactured as a one-piece profile. The manufacturing costs for such a translucent segment are accordingly several times higher than the price for conventional segments. They are therefore—if at all—only applied as narrow windows in a small partial region of the gate body.

From DE 199 15 376 A1 there is moreover known an industrial gate where segments of extruded plastic are applied. These may be made transparent entirely or only in a partial region. As the segments are formed of GFRP (glass fiber reinforced plastic) or PMMA, for example, they have a very low weight in comparison with aluminum segments. The use of these plastic segments of a pliable material in accordance with this known industrial gate is made possible by the fact that the spiral section of the lateral guide has a continuously curved spiral shape, so that the dynamic loads of the gate body may be kept within limits. This industrial gate has been found to be very advantageous for many applications in practical use. It is thus possible to reliably attain very high velocities of up to 3 m/s. At the same time it is also possible to make the gate body essentially transparent throughout.

This industrial gate with plastic segments does, however, also suffer from drawbacks. Namely, these segments have such a low strength in comparison with aluminum segments that they are hardly suited for gate widths exceeding four meters. In addition, these plastic segments furthermore have a shorter lifetime than conventional aluminum segments. In particular it has been found that from a certain gate size upward, cracks may develop in the range in which the strap hinges are fastened to the segments. Another drawback in this design lies in the fact that the segments are extruded as a whole, so that there are limits to variation in terms of materials. In particular, however, it is not possible to modify the constructional shape of the segment without considerable expense; this requires the production of a new extrusion die for each case.

Another essential drawback of this known plastic segment is that owing to the production process, the transparent region is not clear as glass but in particular small processing traces which are, however, clearly recognizable are present in the direction of extrusion.

This fast-moving industrial gate in accordance with DE 199 15 376 A1 has thus been found to be very advantageous for some applications; it is, however, not suited for providing a gate having a substantially transparent gate body that might be capable of replacing a conventional fast-moving spiral gate with aluminum segments in terms of strength properties and suitability for all cases of application.

Here it also is of importance that in some applications, transparent segments are desired only in a partial region of the gate body, whereas in other partial regions or also on the entire gate, for example, recessed segments are provided. Such gate bodies are in particular desirable for the interior range if an air or pressure exchange between the single spaces should be possible, for example. Such modifications and variations are not possible as a general rule with the extruded plastic segments in accordance with DE 199 15 376 A1.

In addition, experimentation was already conducted in the course of the invention to the effect of furnishing a segment which is formed of two profile members extending in the longitudinal direction of the segment and an intermediately arranged panel, i.e., a segment which does not require a vertical web between the profile members. One development aimed at bonding the panel arranged between the profile members into substantially U-shaped profile grooves of the profile members. This approach did, however, not lead to a practically useful result for various reasons: Thus it turned out to be difficult in terms of process technology to perform bonding with such a degree of process security that the center panel will be reliably held in the profile grooves of the profile members. In particular it is difficult to ensure the retaining force—necessary in view of the forces acting on the single segment—for the panel in the respective profile groove of the profile member. One more process-specific drawback in the case of a bonding solution is that a curing time for the adhesive has to be observed, so that corresponding delays and storage facilities must be taken into consideration in production planning.

Problems particularly with respect to a possible use of such a segment for an external gate additionally resulted from the circumstance that the adhesive turned out to be not sufficiently UV-resistant for long-term use. It is another problem, particularly in use as an external gate, that different materials and thus materials having different longitudinal expansion coefficients are used in combination in this case. For example in the event of directly impinging sunlight, this caused internal stresses or distortions in the segments because the profile members made of aluminum exhibit another longitudinal expansion over the length of the segment than the panel made, for example, of PMMA. A movement of one material relative to the other one—which is necessary in order to ensure a sufficient adhesive strength of the intermediate panel on the profile members—is, however, not possible as a result of the continuous bonded connection. In an extreme case, this resulted in damage to the materials or in a destruction of the bonded connection, so that a cohesion of the components of this segment was no longer ensured. This approach thus did not result in a practicable result.

The invention is therefore based on the object of further developing an industrial gate in accordance with the preamble of claim 1 in such a manner that the gate body may be variously designed and in particular also made translucent while preserving its suitability for an external closure as known, for example, from the fast-moving spiral gate. In addition, a corresponding segment as well as a method for manufacturing such a segment are to be proposed by the invention.

This object is attained, in accordance with a first aspect of the invention, through an industrial gate having the features of claim 1. Thus the segments comprise two profile members extending over the length of the segments and an insert panel which is arranged between these and optionally is translucent, wherein the profile members each have a substantially U-shaped profile groove for receiving the longitudinal edges of the insert panel, and wherein one respective elastomer plastic element each is arranged between the longitudinal edges of the insert panel and the inner surface of the profile groove in a press-fit, i.e., under deformation of the plastic element in comparison with the load-free state.

Here it was found in the framework of the invention that surprisingly even press-fitting of an elastomer plastic element between the longitudinal edges of the insert panel and the inner surface of the respective profile groove is sufficient for generating the necessary retaining forces, i.e., enabling a reliable connection of the members. Here the elastomer plastic element acts as a kind of “spring”; specific examinations showed that it stretches when the insert panel is pressed into the U-shaped profile groove, to then contract again when insertion is completed.

In accordance with the invention it is thus possible to produce such a reliable connection between the single elements of each segment that additional webs between the profile members may be omitted. The individual segments may thus be furnished with substantially reduced weight, and the expense of manufacture is clearly reduced even in comparison with the solution implying the webs connected with the aid of bolts or screws. The segments for the industrial gate in accordance with the invention may consequently be furnished at considerably reduced costs.

It is one more advantage of the industrial gate according to the invention that this effective mechanism takes effect irrespective of the material for the insert panel. Hereby the freedom of construction in manufacture of the industrial gate is expanded. For instance, all or even only a few of the segments may be provided with translucent insert panels, or also insert panel of metal including punched holes, and insert panels with a color design etc.. It accordingly is possible to process orders while complying with customers' specific wishes.

It is another essential advantage of the invention that hereby it is for the first time possible to vary the segment width, i.e., the dimensional proportion of the gate body, without any major expense. To this end, in accordance with the invention merely the width of the insert panel needs to be selected in accordance with the desired dimensional proportions of the gate body, whereas such variation in the case of the extruded plastic segments, for example, is only possible through provision of a new extruding tool incurring further costs.

At the same time, the industrial gate in accordance with the invention continues to furnish a reliable external closure and may readily be operated at high velocities of, e.g., 3 m/s. It is moreover suited for large gate widths.

Advantageous developments of the industrial gate in accordance with the invention are the subject matters of appended claims 2 through 8.

The plastic element may, for instance, be made of EPDM, i.e., an ethylene-propylene rubber. This material has been found in trials to be particularly well suited for the purposes of the invention. In particular, this material has good resistivity against weathering and ozone and may reliably be employed at very different temperatures of use. In addition, the mechanical properties of this plastic material are also particularly well suited for materializing the purpose of the invention, i.e., reliable and stable coupling of the insert panel with the profile members.

It is furthermore advantageous if the plastic element is pre-fabricated as a U-profile. This has the effect that the plastic element will reliably come to rest in the desired location and not become dislocated while the press-fit is being produced. This simplifies the production of the segments and increases the reliability of the industrial gate in accordance with the invention.

The legs of the U-profile-shaped plastic element may present a clearance between their free ends having a smaller dimension than the thickness of the insert panel. This has the effect that the plastic element is present with even better stability on the insert panel. The elastomer plastic element may therefore fulfill its function even more reliably.

Owing to the circumstance that recesses are formed in the inner ranges of the legs of the U-shaped plastic element adjacent the transverse web, the plastic element may fit the edge of the insert panel even more accurately. The recesses here ensure that the insert panel may be inserted as far as the transverse web of the plastic element, with the edges being engaged in the recesses at the longitudinal edges of the insert panel. Indeterminate conditions in this range may thus be avoided better.

It is furthermore advantageous if the lateral surfaces of the U-shaped profile groove each comprise a toothing which preferably is oriented in parallel with the bottom surface of the U-shaped profile groove. Owing to this toothing, the retaining force in this location of connection may be increased further. At the same time, the toothing also permits a certain compensation of tolerances between the joined components. The segment having this structure thus presents an improved stability.

If one introduction bevel each is formed at the edges of the opening of the U-shaped profile groove, the elastomer plastic element may be inserted into the profile groove in a more simple and more secure manner. In particular, this introduction bevel controls stretching of the elastomer plastic element during the press-fitting process, so that this step may be performed with higher process security.

It is furthermore advantageous if the press-fit of the plastic element between the edges of the insert panel and the inner surface of the profile groove is such as to generate retaining forces against withdrawal of the insert panel from the profile groove, while at the same time admitting a displacement of the insert panel relative to the profile members in the longitudinal direction of the segment. As a result, this segment is even better suited for an industrial gate which serves as an external closure and thus is exposed to thermal influences such as, e.g., direct insolation. The different longitudinal expansion coefficients of the materials accordingly do not result in any internal stresses in the profile members or on the insert panel, respectively. Instead, the elastomer plastic element absorbs these expansion forces and, because of its elasticity, allows for a relative displacement in the longitudinal direction of the segment. The industrial gate in accordance with the invention may then reliably be employed even for very great gate widths of six meters and more.

In accordance with another aspect of the invention, a segment having the features of claim 9 is provided. This segment may be used for refurnishing or modifying existing industrial gates or also as a replacement part, for instance for damaged segments of an industrial gate in accordance with the invention. By means of this segment, the above mentioned advantages may also be achieved, with further developments as indicated in claims 2 to 8 equally being possible.

In accordance with a yet further aspect of the invention, according to claim 11 a method for manufacturing a segment is proposed which comprises the steps: positioning opposed longitudinal edges of an insert panel with respect to a respective U-shaped profile groove on two profile members extending over the length of the segment, arranging an elastomer plastic element each between the longitudinal edges of the insert panel and the U-shaped profile groove, and bringing together the insert panel and the profile members, with the elastomer plastic element being pressed therebetween and deforming in the process.

This method is characterized in that a segment having the desired properties may reliably be manufactured at high process security and comparatively small expense in terms of construction. In particular it is possible to avoid process problems such as, for instance, in the above discussed bonding of the panel in the profile members, for in accordance with the invention it is possible to entirely do away with bonding.

In another embodiment, the plastic element may be given the shape of a U-profile and be inserted on the respective longitudinal edge of the insert panel. Hereby the method may be simplified further and implemented with even higher process security.

The invention will be explained in more detail hereinbelow by referring to the figures of the drawing, wherein:

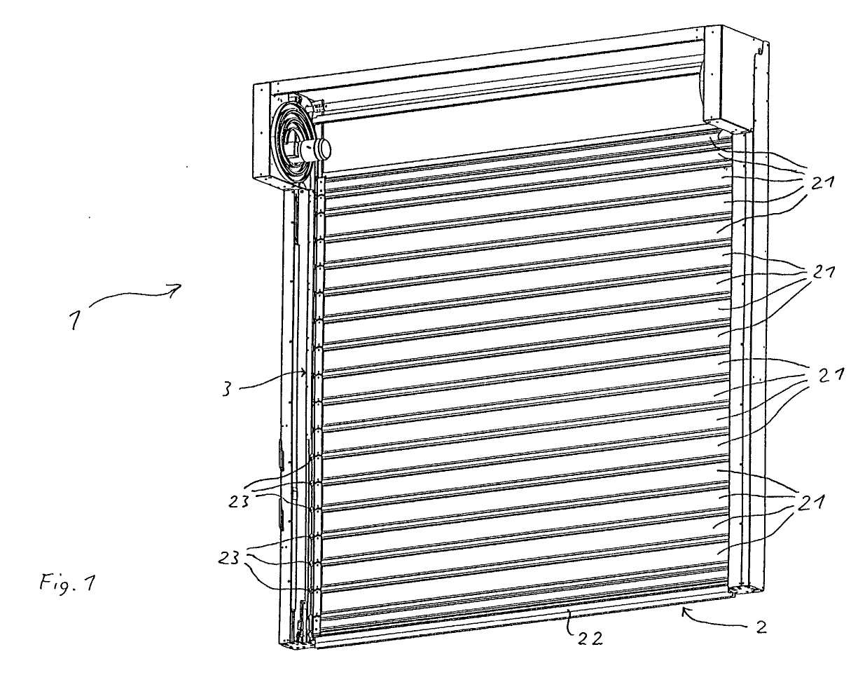

FIG. 1 is a schematic representation in perspective view of an industrial gate to which the invention is applicable;

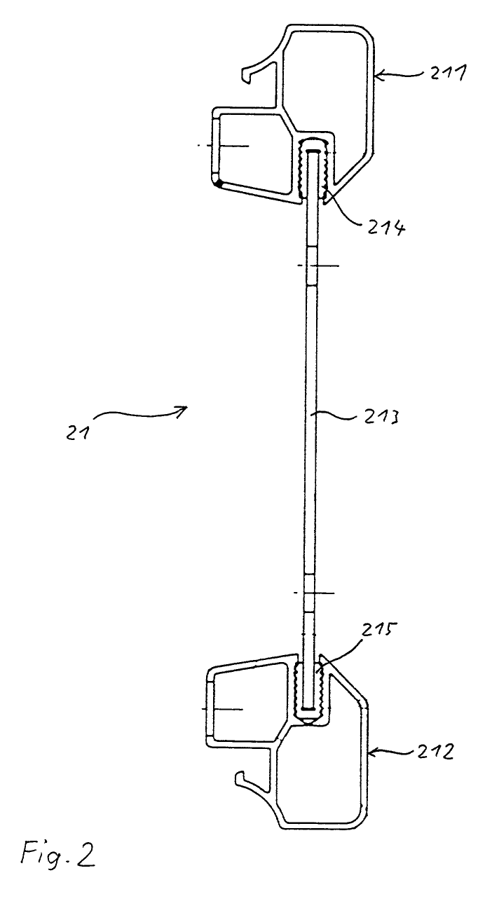

FIG. 2 is a sectional view of a segment of the invention;

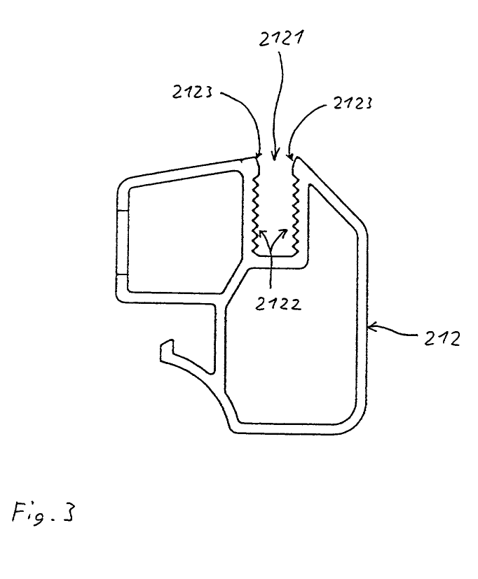

FIG. 3 shows a profile member in an enlarged representation;

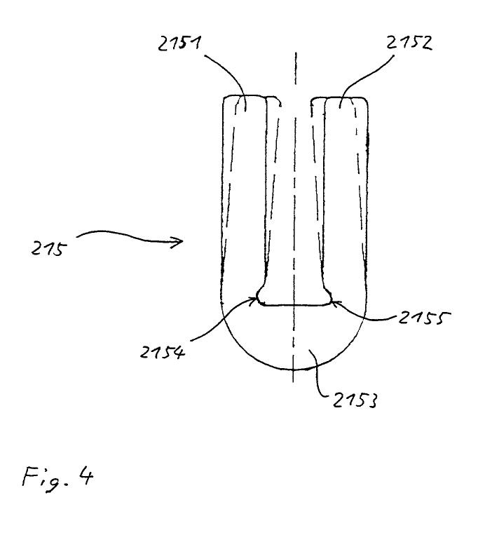

FIG. 4 shows an elastomer plastic element in an enlarged representation; and

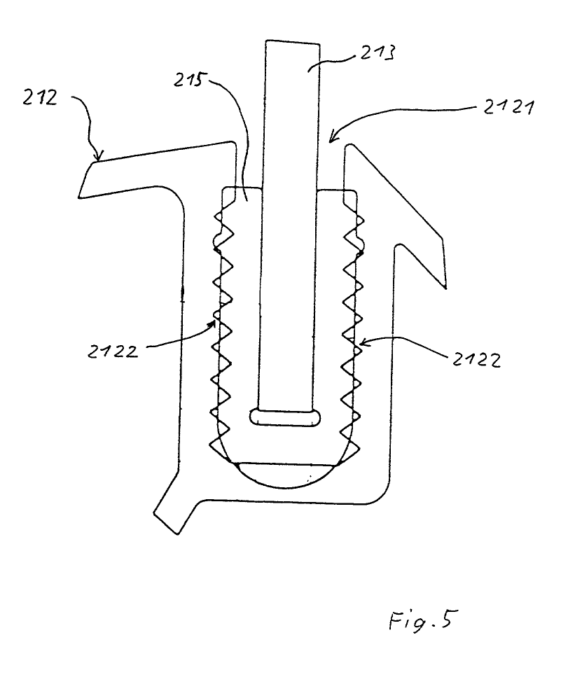

FIG. 5 is an enlarged representation of a detail of the segment of the invention in FIG. 2.

In accordance with the representation in FIG. 1, an industrial gate 1 has a gate body 2 comprising a multiplicity of segments 21 which are interconnected such that they may be oriented at a relative angle, as well as a terminating profile 22 for floor-side termination. In FIG. 1, the industrial gate 1 is shown in the opened state in which the gate body 2 is wound into a spiral in the range of the lintel which is not represented.

The segments 21 are interconnected with the aid of hinge means not shown here; these hinge means may be single hinges between the segments, or also a strap hinge continuously extending over the height of the gate body in the ranges of the lateral edges of the gate body 2. In addition, at the lateral edges of the gate body 2 there are arranged in a known manner a plurality of rollers 23 which engage the guide rails 3 and serve for lateral guidance of the gate body 2.

FIG. 2 shows a sectional view of a segment 21. The segment 21 comprises two profile members 211 and 212 each formed as a mirror image of the other and being present in the assembled state in a neighboring relation with the adjacent segment. Between the profile members 211 and 212 an insert panel 213 is arranged which is indirectly connected with the profile members 211 and 212 through the intermediary of respective elastomer plastic elements 214 and 215.

FIG. 3 is a more detailed representation of the profile member 212. It includes a profile groove 2121 with an inner surface comprising a toothing 2122. The toothing 2122 is formed such that the teeth extend in parallel to the bottom of the profile groove 2121. Moreover at the open end of the profile groove 2121 on either side a respective introduction bevel 2123 is formed. The further geometry of the profile member 212 is defined in a known manner through the structure of the gate body 2, so that a detailed explanation in this respect may be omitted here.

FIG. 4 is a cross-sectional view of the elastomer plastic element 215. It is produced as a molded part of EPDM and comprises two legs 2151 and 2152 interconnected through the intermediary of a transverse web 2153. On the inside of the plastic element 215 thus having the form of a U-profile there are furthermore formed recesses 2154 and 2155 each present at the transition between the legs 2151 and 2152, respectively, and the transverse web 2153.

The shape of the plastic element 215 represented by a solid line in FIG. 4 corresponds to the assembled position, i.e., the inserted position on the insert panel 213. In FIG. 4 the state before assembly of the plastic element 215 is additionally indicated by a broken line. From this it can be seen that the legs 2151 and 2152 of the plastic element 215 present between their free ends a clearance having a smaller dimension than the thickness of the insert panel 213.

The profile member 211, not described here in detail, is formed in analogy, i.e., as a mirror image of the profile member 212, as can be seen in FIG. 2. The shape of the plastic element 214, also not described in detail, corresponds to that of the plastic element 215, and is inserted on the other longitudinal edge of the insert panel 213, only in an opposite orientation.

FIG. 5 shows in more detail and in schematic representation how the individual elements of a segment 21 are interconnected. In order to produce this connection, the plastic element 215 is initially inserted on a longitudinal edge of the insert panel 213 which is only represented here in part. Subsequently these pre-assembled elements are fitted into the profile groove 2121 of the profile member 212 only shown in part here. The elastomer plastic element 215 is elastically deformed in the process. While being stretched, it slides into profile groove 2121, optionally by way of the introduction bevels 2123 (cp. FIG. 3). As soon as the fitting process is concluded, the elastomer plastic element 215 tends to contract again and is finally immobilized in the space present in the cavity of the profile groove 2121. In particular, the plastic element 215 enters into engagement with the toothing 2122. As the plastic element 215 at the same time comes to lie inside profile groove 2121 while being lastingly deformed, the pressure is also transmitted to the major surfaces at the longitudinal edge of the insert panel 213, whereby the latter is retained reliably. The connection in the range of the profile member 211 is established analogously.

The insert panel 213 is thus clamped fixedly and yet furthermore elastically between the profile members 211 and 212. As a result, a very high retaining force—a typical amount is about 300 N/dm—against withdrawal of the insert panel 213 from the profile members 211 and 212 is attained on the one hand, and yet a displacement of the insert panel 213 relative to profile members 211 and 212 particularly in the longitudinal direction of the segment is possible on the other hand, so that internal stresses owing to a different expansion of the materials under thermal influences may be avoided. In practical trials it has been found that the elasticity of the plastic element is overcome from a certain point, with a (reversible) sliding displacement taking place at the boundary surfaces. This sliding displacement occurs where the friction is lowest, such as, e.g., between the insert panel or the web on the one hand and the elastomer plastic element on the other hand.

It accordingly is possible to combine most different materials, with aluminum or an aluminum alloy such as AlMgSi 0.5 F22 or also a plastic such as a GFRP or PMMA being preferably used for the profile members. The insert panel may be formed of transparent PMMA or also of another plastic such as PVC or PC. It moreover is also possible for the insert panel to be formed of metal and/or contain openings for exchange of air between the spaces that are kept closed from each other.

Besides the embodiment presently set forth, the invention allows for further design approaches.

The plastic element may thus also be formed of an elastomer other than EPDM. One example herefor, besides NBR, CR, TPE and EPM, also is a butyl rubber or neoprene-polychloroprene.

The plastic element moreover need not be pre-fabricated as a U-profile but may also be supplied as a planar body, to be positioned in a central position between the profile groove 2121 and the edge of the insert panel 213 and then press-fitted. It is furthermore not necessary for the free ends of the legs 2151 and 2152 of the plastic element 215 to have a clearance smaller than the thickness of the insert panel 213. It is equally possible to omit the recesses 2154 and 2155.

In accordance with the invention, it is possible to do without bonding at the location of connection of insert panel 213/plastic element 215, or plastic element 215/profile groove 2121. In particular applications it is, however, also possible to additionally provide single bonding points or even continuous bonding in the profile groove in order to enhance the retaining force of the connection.

The insert panel may as an alternative also be a multi-layered panel designed, e.g., in sandwich construction. It is thereby possible i. a. to imbue the insert panel with thermal insulation properties.

It is furthermore also possible to form the profile groove 2121 without a toothing and/or also without an introduction bevel 2123. The border areas of the insert panel co-operating with the plastic element 15 may furthermore be provided with friction-increasing means such as, e.g., a coating or a surface structure (fluting or ribbing).

The invention is moreover applicable not only to single-walled segments, but also to double-walled segments, in which case the respective segment walls will be formed in analogy with the single-walled segment of profile members with profile grooves, elastomer plastic elements, and an insert panel. With regard to further details, reference is also made to the German patent application deposited by the same applicant on the same application date under attorney's file wrapper No. EF01K27 and entitled “Industrial gate, double-walled segment for an industrial gate, and method for manufacturing such a segment.” In that application a concrete embodiment herefor is shown, which is herewith fully incorporated by reference.

1. Industrial gate (1) having a gate body covering the gateway (2) and comprising a multiplicity of segments (21) which are interconnected such that they may be oriented at a relative angle, and which may be formed to be translucent in a center region,
characterized in that
said segments (21) comprise two profile members (211, 212) extending over the length of said segments (21) and an insert panel (213) which is arranged between these and optionally is translucent,
said profile members (211, 212) each having a substantially U-shaped profile groove (2121) for receiving the longitudinal edges of said insert panel (213), and one respective elastomer plastic element (214, 215) each being arranged between the longitudinal edges of said insert panel (213) and the inner surface of said profile groove (2121) in a press-fit, i.e., under deformation of said plastic element (214, 215) in comparison with the load-free state.

2. Industrial gate in accordance with claim 1, characterized in that said plastic element (214, 215) is formed of EPDM.

3. Industrial gate in accordance with claim 1 or 2, characterized in that said plastic element (214, 215) is pre-fabricated as a U-profile.

4. Industrial gate in accordance with claim 3, characterized in that the legs (2151, 2152) of said U-profile-shaped plastic element (214, 215) present a clearance between their free ends having a dimension smaller than the thickness of said insert panel (213).

5. Industrial gate in accordance with claim 3 or 4, characterized in that recesses (2154, 2155) are formed at the inner ranges of said legs (2151, 2152) of said U-profile-shaped plastic element (214, 215) adjacent said transverse web (2153).

6. Industrial gate in accordance with any one of claims 1 to 5, characterized in that the lateral surfaces of said U-shaped profile groove (2121) each comprise a toothing (2122) which preferably is oriented in parallel with the bottom surface of said U-shaped profile groove (2121).

7. Industrial gate in accordance with any one of claims 1 to 6, characterized in that one introduction bevel (2123) each is formed at the edges of the opening of said U-shaped profile groove (2121).

8. Industrial gate in accordance with any one of claims 1 to 7, characterized in that the press-fit of said plastic element (214, 215) between the edges of said insert panel (213) and the inner surface of said profile groove (2121) is such as to generate retaining forces against withdrawal of said insert panel (213) from said profile groove (2121), while at the same time admitting a displacement of said insert panel (213) relative to said profile members (211, 212) in the longitudinal direction of said segment (21).

9. A segment (21), in particular for an industrial gate (1) in accordance with any one of claims 1 to 8, characterized in that
it comprises two profile members (211, 212) extending over the length of said segment (21) and an insert panel (213) which is arranged between these and optionally is translucent,
said profile members (211, 212) each having a substantially U-shaped profile groove (2121) for receiving the longitudinal edges of said insert panel (213), and an elastomer plastic element (214, 215) being arranged between the longitudinal edges of said insert panel (213) and the inner surface of said profile groove (2121) in a press-fit, i.e., under deformation of said plastic element (214, 215) in comparison with the load-free state.

10. A segment in accordance with claim 9, characterized in that it is further developed by at least one of the features of claims 2 to 8.

11. A method for manufacturing a segment (21) in accordance with claim 8 or 9, comprising the steps:
positioning opposed longitudinal edges of an insert panel (213) with respect to a respective U-shaped profile groove (2121) on two profile members (211, 212) extending, over the length of said segment (21);
arranging an elastomer plastic element (214, 215) each between the longitudinal edges of said insert panel (213) and said U-shaped profile groove (2121); and
bringing together said insert panel (213) and said profile members (211, 212), said elastomer plastic element (214, 215) being pressed therebetween and deforming in the process.

12. A method in accordance with claim 11, characterized in that said plastic element (214, 215) is given the shape of a U-profile and is inserted on the respective longitudinal edge of said insert panel (213).
